(19) United States
(12) Patent Application Publication
(10) Pub. No.: US 2005/0222878 A1
(43) Pub. Date: Oct. 6, 2005

(54) Method of managing the business of a medical scheme

(76) Inventors: Kenneth Steven Rabson, Johannesburg (ZA); Adrian Gore, Houghton Estate (ZA); Herschel Phillip Mayers, Johannesburg (ZA)

Correspondence Address: MARSHALL & MELHORN, FOUR SEAGATE, EIGHT FLOOR, TOLEDO, OH, 43604, US

(21) Appl. No.: 10/819,256

(22) Filed: Apr. 6, 2004

(51) Int. Cl. G06F 17/60

(52) U.S. Cl. 705/4; 705/2

(57) ABSTRACT

The present invention relates to a method of managing the business of a medical scheme wherein the provider of such medical scheme undertakes liability in return for a premium or contribution, and provides to members who pay such premiums or make such contributions, relevant health services, and/or assistance in defraying expenses incurred in connection with rendering such relevant health services. The improvement comprises in the allocating of a portion of the premium or contribution paid by a member to provide the indemnity benefit and if the member suffers severe illness, disability or death, the member's future premium or contribution is paid on behalf of the member to the medical scheme for a period of time so that the provider of the medical scheme continues to undertake liability for the member and/or dependent's of the member for the period of time.

### BACKGROUND OF THE INVENTION

The present invention relates to a method of managing the business of a medical scheme.

A traditional medical scheme operates where the provider of the medical scheme undertakes liability in return for a premium or contribution and provides to members who pay such premiums or make such contributions, relevant health services and or assistance in defraying expenses incurred in connection with rendering such relevant health services.

The aim of these type of medical schemes is to give members access to the best health services which they may otherwise not be able to afford.

A life-changing event such as where a member suffers disability or death drastically affects the members financial position and the financial position of dependents of the member. The financial impact is often so severe that the member is no longer able to pay the premium or contribution and as such their future access to health services is jeopardised at a point where they may in fact need these health services more than ever before.

The present invention seeks to address this.

### SUMMARY OF THE INVENTION

According to the present invention there is provided, in a method of managing the business of a medical scheme, wherein the provider of such medical scheme undertakes liability in return for a premium or contribution, and provides to members who pay such premiums or make such contributions, relevant health services, and/or assistance in defraying expenses incurred in connection with rendering such relevant health services, the improvement comprising:
allocating a portion of the premium to provide an indemnity benefit whereby;
if the member suffers severe illness, disability or death, paying the member's future premium or contribution on behalf of the member to the medical scheme for a period of time so that the provider of the medical scheme continues to undertake liability for the member and/or dependents of the member for the period of time.

Preferably, the period of time is a pre-selected period of time or is a period of time until the member reaches a pre-selected age.

A plurality of severe illnesses and disabilities may be categorised into a severity A level or a severity B level and wherein if the member suffers a severity A level severe illness or disability their future premium or contribution is paid for the pre-selected period of time, but if the member suffers a severity B level severe illness or disability their future premium or contribution is only paid for a shorter period of time.

If the member suffers a plurality of severity B level severe illnesses or disabilities, their future premium or contribution may be paid for a plurality of shorter periods of time, one period of time for each occurrence of the severity B level severe illness or disability, provided that the plurality of shorter periods do not add up to more than the total pre-selected period of time.

If the member dies the future premium or contribution made on behalf of the member to the medical scheme may be paid for a period of time so that the provider of the medical scheme continues to undertake liability for the dependents of the member for the period of time, provided that the dependents remain alive and, in the case of children, remain below a certain predetermined age.

### DESCRIPTION OF PREFERRED EMBODIMENTS

The present invention finds application in the field of managing the business of a medical scheme. Typically, the provider of such medical schemes undertakes liability in return for a premium or contribution, and provides to members who pay such premiums or make such contributions, relevant health services and or assistance in defraying expenses incurred in connection with rendering such health services.

According to the present invention, a portion of the premium or contribution paid by a member is used to provide for future premiums or contributions made on behalf of the member to the medical scheme.

It will be appreciated that this indemnity benefit will preferably be operated by the medical scheme itself but in some cases may be operated by an associated partner who assumes the liability for the additional contribution. This will particularly be the case in countries where medical schemes cannot assume such liability.

If the member suffers disability or death, the member's future premium or contribution is paid on behalf of the member for a period of time so that the provider of the medical scheme continues to undertake liability for the member and or dependents of the member for the period of time.

Typically, the premium or contribution is paid by the member on a monthly basis to the medical scheme.

Once a portion of the premium or contribution is allocated towards providing this indemnity benefit, the member becomes an “insured life”. Typically, the member will have their dependents as part of their health plan and in the case of the insured life dying, payments will be made on behalf of the member so that the member's dependents continue to remain on the health plan.

If the member should become severely ill or disabled, the payments to the medical scheme will cover the premium or contribution for the member as well as for the dependents of the member.

The period of time for which the premium or contribution is paid on behalf of the member can be selected by the member. For example, the period of time could be 5, 10 or 15 years or until the member reaches a predetermined age such as 65, for example.

This payment period is pre-selected by the member when they commence contributing for the indemnity benefit and the portion of the premium or contribution paid by the member for the indemnity benefit will be linked to the period of time.

In addition, severe illness or disability is categorised into a severity A level and a severity B level where if the member suffers a severity A level illness or disability, their future premiums or contributions are paid for the full period of time pre-selected by them.

Where the member suffers a severity B level illness or disability, the member's future premiums or contributions are paid for a reduced period of time, such as two years, for example. If at a later stage the member suffers another severity B illness or disability, their future premiums or contributions can be paid for a further period of two years and this can be repeated provided the total of these smaller periods does not exceed the full period of time pre-selected by the member.

In the event of an illness progressing from a severity B claim to a severity A claim, the payments will be made for the balance of the pre-selected period of time.

As mentioned above, members typically have dependents on their health plan. For example, a member's wife and children will also be covered on their health plan.

Payments covering dependents will be for as long as the dependent is below a certain age in the case of a child, for example 21 years of age. Payments will also only cover a dependent whilst they are still alive. Thus, death of a dependent will mean that the premiums or contributions to the medical scheme will reduce.

It is envisaged that the benefit will not cover any new dependents added to the health plan of the member during the stage where the premiums or contributions are being paid on the member's behalf. An exception will be in the event of a baby being born to the member and their spouse within nine months of the first payment being made on the member's behalf.

Thus it will be appreciated that the present invention provides a method of managing the business of a medical scheme whereby the members of the scheme and/or their dependents are able to enjoy the benefits of the scheme after they have suffered a severe illness, disability or death.

1. In a method of managing the business of a medical scheme wherein the provider of such medical scheme undertakes liability in return for a premium or contribution, and provides to members who pay such premiums or make such contributions, relevant health services, and/or assistance in defraying expenses incurred in connection with rendering such relevant health services, the improvement comprising:
allocating a portion of the premium to provide an indemnity benefit whereby;
if the member suffers severe illness, disability or death, paying the member's future premium or contribution on behalf of the member to the medical scheme for a period of time so that the provider of the medical scheme continues to undertake liability for the member and/or dependent's of the member for the period of time.

2. A method according to claim I wherein the period of time is a pre-selected period of time or is a period of time until the member reaches a pre-selected age.

3. A method according to claim 2 wherein a plurality of severe illnesses and disabilities are categorised into a severity A level or a severity B level and wherein if the member suffers a severity A level severe illness or disability their future premium or contribution is paid for the pre-selected period of time, but if the member suffers a severity B level severe illness or disability their future premium or contribution is only paid for a shorter period of time.

4. A method according to claim 3 wherein if the member suffers a plurality of severity B level severe illnesses or disabilities, their future premium or contribution is paid for a plurality of shorter periods of time, one period of time for each occurrence of the severity B level severe illness or disability, provided that the plurality of shorter periods do not add up to more than the total pre-selected period of time.

5. A method according to claim 4 wherein if the member dies the future premium or contribution on behalf of the member to the medical scheme is paid for a period of time so that the provider of the medical scheme continues to undertake liability for the dependent's of the member for the period of time, provided that the dependent's remain alive and, in the case of children, remain below a certain predetermined age.
